(19) United States
(12) Patent Application Publication
(10) Pub. No.: US 2014/0130828 A1
(43) Pub. Date: May 15, 2014

(54) Method of Cleaning Tire Valve and Cleaning Tool

(71) Applicants: Takumi Sekiguchi, Hiratsuka-shi (JP); Daisuke Kanenari, Hiratsuka-shi (JP)

(72) Inventors: Takumi Sekiguchi, Hiratsuka-shi (JP); Daisuke Kanenari, Hiratsuka-shi (JP)

(73) Assignee: The Yokohama Rubber Co., LTD., Minato-ku, Tokyo (JP)

(21) Appl. No.: 14/130,293

(22) PCT Filed: Jun. 20, 2012
(86) PCT No.: PCT/JP2012/065734

§ 371 Date: Jan. 29, 2014

(30) Foreign Application Priority Data
Jun. 30, 2011 (JP) 2011-146479

(51) Int. Cl. B60C 25/18

(52) U.S. Cl. CPC B60C 25/18
USPC 134/6; 15/104.05

(57) ABSTRACT

A method of cleaning a tire valve may include: using a tire valve cleaning tool provided with a cleaning part made from a flexible member, and a holder part that communicates with the cleaning part, a maximum outer diameter of the cleaning part being from 50% to 200% of a minimum inner diameter of the tire valve; removing the valve core from a tire valve installed on a wheel, and removing the foreign material adhered to the inner face of the tire valve with the cleaning part.

### TECHNICAL FIELD

The present technology relates to a method of cleaning a tire valve installed on a wheel, and a cleaning tool. Specifically, the present technology relates to a method of cleaning a tire valve, and a cleaning tool which removes foreign material adhered to an inner face of a tire valve, making it possible to avoid having to replace the tire valve due to the adherence of foreign material.

### BACKGROUND ART

In recent years, when the tire mounted on a vehicle has punctured, a puncture repair fluid is injected into the tire via a tire valve to thereby temporarily repair the puncture, while, at the same time, filling the tire with air (refer to, for example, Japanese Unexamined Patent Application Publication No. 2010-069847 and Japanese Unexamined Patent Application Publication No. 2010-070251).

However, on using this puncture repair method, the puncture repair fluid adhered to the inner face of the tire valve hardens, and there is the problem that the adhering material tends to impede removal or attachment of the valve core, or cause the leakage of air.

Currently, when foreign material such as the puncture repair fluid and the like adheres to the inner face of the tire valve as described above, the valve core is replaced. That is, since the valve core is cheap and the replacement is also easy to perform, it is more practical to simply replace the valve core itself.

Incidentally, in recent years, there have been proposed pneumatic tires having a detecting device which detects tire internal information such as air pressure or temperature integrated with the tire valve. If the tire valve and the detecting device are integrated in this manner, it is impossible to replace just the tire valve. Therefore, a means for easy and satisfactory removal of the foreign material adhered to the inner face of the tire valve is needed.

### SUMMARY

The present technology provides a method of cleaning a tire valve and a cleaning tool that removes foreign material adhered to an inner face of a tire valve, and makes it possible to avoid having to replace the tire valve due to the adherence of foreign material.

A method of cleaning a tire valve according to the present technology includes: using a tire valve cleaning tool provided with a cleaning part made from a flexible member, and a holder part communicating with the cleaning part, a maximum outer diameter of the cleaning part being from 50% to 200% of a minimum inner diameter of the tire valve; removing the valve core from a tire valve installed on a wheel; and removing the foreign material adhered to an inner face of the tire valve with the cleaning part.

A tire valve cleaning tool according to the present technology, which solves the above-mentioned problems, includes a cleaning part made from a flexible member, and a holder part communicating with the cleaning part, a maximum outer diameter of the cleaning part being from 50% to 200% of a minimum inner diameter of a tire valve.

Using a tire valve cleaning tool provided with a cleaning part made from a flexible member, and a holder part communicating with the cleaning part, and with the maximum outer diameter of the cleaning part being from 50% to 200% of the minimum inner diameter of the tire valve, it is possible in the present technology to easily and satisfactorily remove the foreign material adhered to the inner face of the tire valve. Thus, it is possible to avoid replacing the valve because of foreign material adhered to the inner face of the tire valve, allowing the tire valve to be used as is.

In the present technology, a length of the cleaning part is preferably from 5 mm to 100 mm. In addition, the cleaning part preferably has a core running along a longitudinal direction of the cleaning part. This ensures satisfactory operability when removing foreign material.

The cleaning part preferably has a non-circular cross-sectional shape in a direction orthogonal to the longitudinal direction of the cleaning part. Moreover, the outer diameter or a shape of the cleaning part is preferably varied along the longitudinal direction of the cleaning part. This improves the ability to remove foreign material.

The tire valve cleaning tool is preferably provided with a pair of cleaning parts which serve as the above-described cleaning part. A first cleaning part is preferably made from an absorber that absorbs a liquid-state foreign material, while a second cleaning part is preferably made from a scraper that scraps off a solid-state foreign material. This allows suitable removal of solid-state and liquid-state foreign materials.

### BRIEF DESCRIPTION OF THE DRAWINGS

FIG. 1 is a perspective view illustrating a state where a pneumatic tire is repaired using a puncture repair liquid.

FIG. 2 is a cross-sectional view illustrating a tire valve with a valve core removed therefrom.

FIG. 3 is a side view illustrating an example of a tire valve cleaning tool used in the present technology.

FIG. 4 is a side view illustrating a modification example of the tire valve cleaning tool used in the present technology.

FIG. 5 is a side view illustrating a modification example of the tire valve cleaning tool used in the present technology.

FIG. 6 is a side view illustrating a modification example of a tire valve cleaning tool used in the present technology.

FIG. 7 illustrates various cleaning parts of a tire valve cleaning tool used in the present technology; FIGS. 7A to 7G are respectively the front views when viewed from the tip end side of the cleaning part.

FIG. 8 illustrates an example of a cleaning part of the tire valve cleaning tool used in the present technology; FIG. 8A is a side view of the cleaning part, and FIG. 8B is a front view when the cleaning part is viewed from the tip end side.

FIG. 9 illustrates a modification example of the cleaning part of the tire valve cleaning tool used in the present technology; FIG. 9A is a side view of the cleaning part, and FIG. 9B is a front view when the cleaning part is viewed from the tip end side.

FIG. 10 illustrates a modification example of the cleaning part of the tire valve cleaning tool used in the present technology; FIG. 10A is a side view of the cleaning part, and FIG. 10B is a front view when the cleaning part is viewed from the tip end side.

FIG. 11 illustrates a modification example of the cleaning part of the tire valve cleaning tool used in the present technology; FIG. 11A is a side view of the cleaning part, and FIG. 11B is a front view when the cleaning part is viewed from the tip end side.

FIG. 12 illustrates a modification example of the cleaning part of the tire valve cleaning tool used in the present technology; FIG. 12A is a side view of the cleaning part, and FIG. 12B is a front view when the cleaning part is viewed from the tip end side;

FIG. 13 is a perspective view illustrating a tire valve provided with a sensor unit.

FIG. 14 is a cross-sectional view illustrating a tire valve provided with a sensor unit.

### DETAILED DESCRIPTION

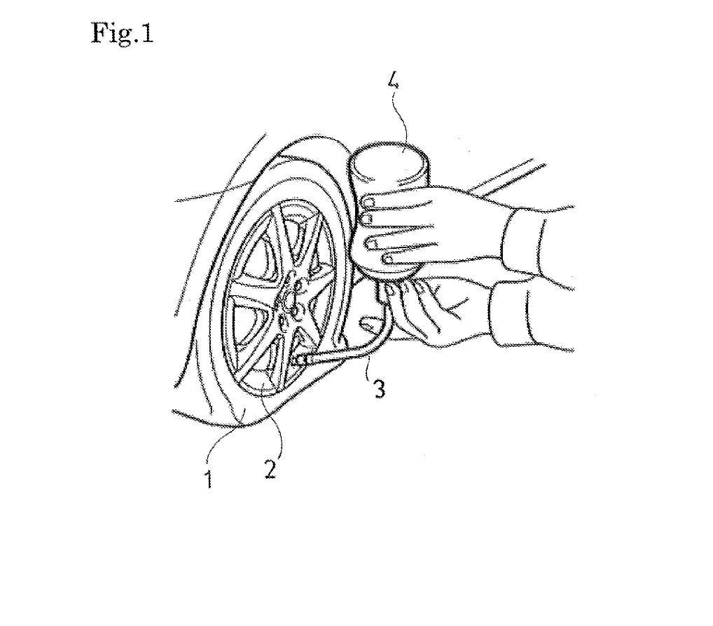

Detailed descriptions will be given below of a configuration of the present technology with reference to the accompanying drawings. FIG. 1 illustrates a state where a pneumatic tire is repaired using a puncture repair liquid. As illustrated in FIG. 1, when a pneumatic tire 1 is punctured, for example, a valve core is removed from a tire valve installed on a wheel 2, a container 4 containing puncture repair fluid is connected to the tire valve via a tube 3, and the puncture repair fluid is injected into the pneumatic tire 1 via the tube 3. Then, after installing the valve core in the tire valve, the pneumatic tire 1 is filled with air, and thereby allows a necessary minimum amount of travel. However, if the puncture repair fluid adhered to an inner face of the tire valve hardens, the adhered material tends to impede removal or attachment of the valve core, or may cause air leakage. Therefore, it is necessary to appropriately remove the liquid-state and solid-state puncture repair fluid adhered to the inner face of the tire valve.

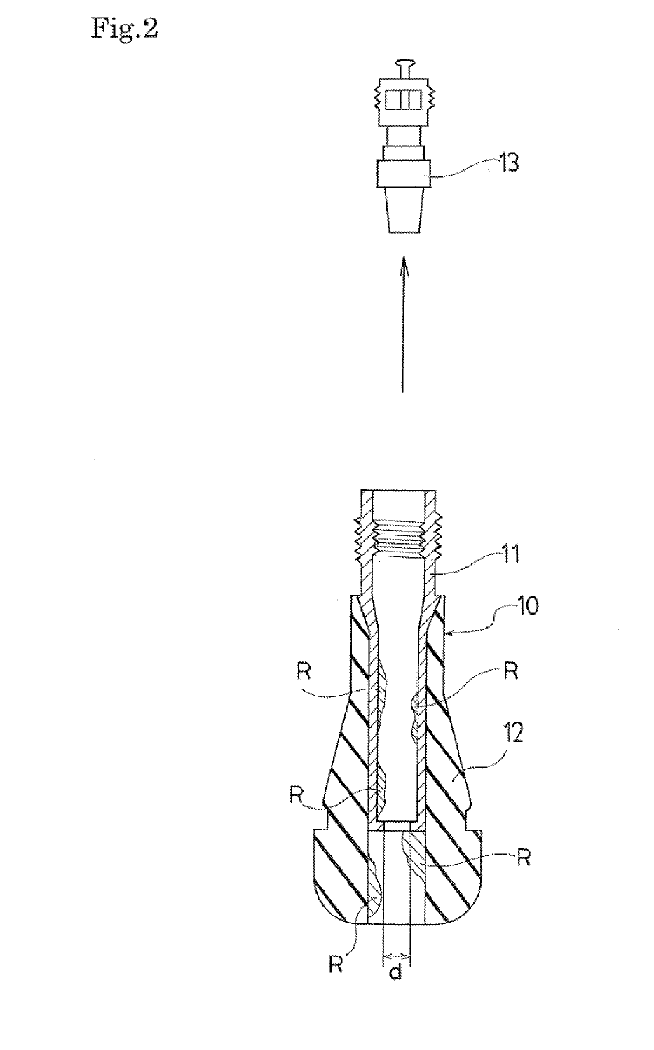

FIG. 2 illustrates a state where the valve core is removed from the tire valve. In FIG. 2, a tire valve 10 is constituted by a valve stem 11 formed into a cylinder shape, a rubber covering layer 12 that covers a base end side of the valve stem 11, and a valve core 13 that screws into the valve stem 11. When the above-described kind of puncture repair method is used, the condition is such that a puncture repair fluid R adheres to the inner face of the tire valve 10 (valve stem 11).

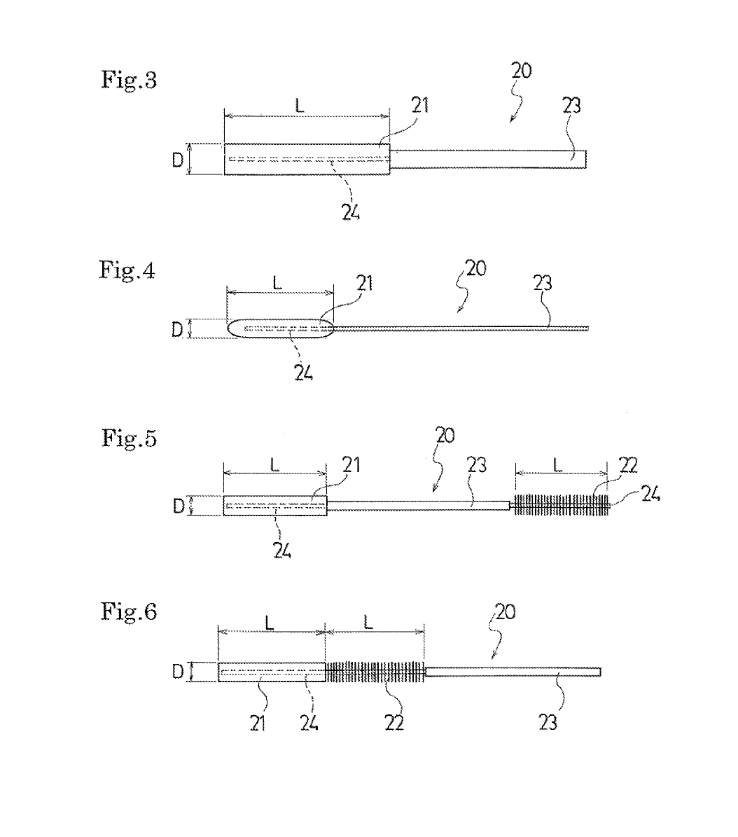

FIGS. 3 to 6 each illustrate a tire valve cleaning tool used in the present technology. In FIG. 3 and FIG. 4, a tire valve cleaning tool 20 is provided with a cleaning part 21 made from a flexible member, and a holder part 23 that communicates with the cleaning part 21. In FIG. 5 and FIG. 6, the tire valve cleaning tool 20 is provided with a pair of cleaning parts 21, 22 made from flexible members, and a holder part 23 that communicates with the cleaning parts 21, 22. More specifically, in the example illustrated in FIG. 5, the cleaning parts 21, 22 are disposed on both ends of the holder part 23, and in the example illustrated in FIG. 6, the cleaning parts 21, 22 are disposed adjacent to each other on one end of the holder part 23.

Here, “flexible” means capable of deformation with little force. The amount of force required for the deformation is preferably not greater than 50 N. Examples of constituent elements for the cleaning parts 21, 22 include rubber, sponge, woven fabrics, non-woven fabrics, and brushes. In FIGS. 3 to 6, rubber, sponge, woven or non-woven fabrics are used for the cleaning part 21, while a brush is used for the cleaning part 22. As illustrated in FIG. 5 and FIG. 6, if the tire valve cleaning tool 20 is provided with the pair of cleaning parts 21, 22, and the first cleaning part 21 is made from an absorber (rubber, sponge, woven fabric or non-woven fabric) that functions to absorb the liquid-state foreign material, while the second cleaning part 22 is made from a scraper (brush) that functions to scrape off the solid-state foreign material, the solid-state and liquid-state foreign material can be appropriately removed.

In FIGS. 3 to 6, the cleaning parts 21, 22 each have a rigid core 24 that runs along the longitudinal direction. In the examples in FIGS. 3, 5 and 6, the core 24 is a separate member from the holder part 23, but in the example in FIG. 4, the core 24 is integrally formed with the holder part 23. Here, ‘rigid’ means at least tending to deform less than the cleaning parts 21, 22. Examples of constituent materials that may be used for the core 24 include metal, or synthetic resins, and the like. In this manner, providing the core 24 in the cleaning parts 21, 22 facilitates insertion of the cleaning parts 21, 22 into the tire valve 10. However, the core 24 is not essential.

When using the above-described tire valve cleaning tool 20 to clean the tire valve 10, first, the valve core 13 is removed from the tire valve 10 installed on the wheel 2; the cleaning parts 21, 22 are inserted into the tire valve 10 while holding the holder part 23 of the tire valve cleaning tool 20 in hand. Next, the foreign material including the puncture repair fluid R adhered to the inner face of the tire valve 10 is removed by the cleaning parts 21, 22. Hereby, the foreign material adhered to the inner face of the tire valve 10 is easily and satisfactorily removed. Therefore, there is no need to replace the tire valve 10 that had foreign material adhered thereto, and the tire valve 10 may be used as it is. This is extremely effective particularly when the tire valve 10 is integrated with a detecting device that detects tire internal information such as air pressure and temperature. In the tire valve cleaning tool 20, a maximum outer diameter D of the cleaning parts 21, 22 is set to be from 50% to 200% of a minimum inner diameter d (refer to FIG. 2) of the tire valve 10. The definition of this range is based on experimentation; selecting such a range thereby supports both the ability to remove foreign material and operability. If the maximum outer diameter D of the cleaning parts 21, 22 is less than 50% of the minimum inner diameter d of the tire valve 10, it tends to be difficult to remove the foreign material. Conversely, if the maximum outer diameter D of the cleaning parts 21, 22 is greater than 200%, it tends to be difficult to insert the cleaning parts 21, 22 into the tire valve 10.

Additionally, the length L of the cleaning parts 21, 22 is preferably from 5 mm to 100 mm. The definition of this range is based on experimentation; selecting such a range thereby ensures that there is satisfactory operability when removing foreign material. If the length L of the cleaning parts 21, 22 is less than 5 mm, the operability when removing foreign material deteriorates; conversely if the length L of the cleaning parts 21, 22 is greater than 100 mm, it tends to be difficult to insert the cleaning parts 21, 22 into the tire valve 10.

The size of the level difference from recesses and protrusions formed on a surface of the cleaning part 21 is preferably not less than 0.1 mm and more preferably from 0.3 mm to 1.0 mm. Here, the size of the level difference from the recesses and protrusions means the height difference between the lowest region and the highest region from the recesses and protrusions formed on a surface of a member. Although the cleaning part 21 is made from an absorber (rubber, sponge, woven or non-woven fabric) that functions to absorb the liquid-state foreign material, setting the size of the level difference from the recesses and protrusions to the above-mentioned range thereby improves the ability to remove the foreign material. That is to say, it is possible to add the functions of scraping and seizing the foreign material, to the cleaning part 21. Particularly, if the cleaning part 21 is made from sponge, the density is preferably not more than 0.3 g/cm³ and more preferably from 0.15 g/cm³ to 0.25 g/cm³.

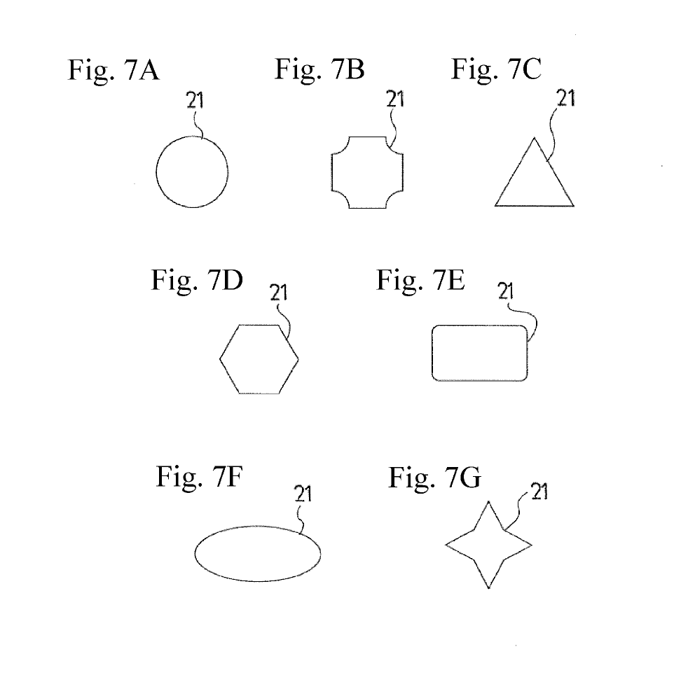

FIGS. 7A to 7G illustrate various cleaning parts of the tire valve cleaning tool used in the present technology viewed from the tip end side. As illustrated in FIGS. 7A to 7G, various shapes may be adopted for the cleaning part 21. In particular, if instead of making the cross-sectional shape in the direction orthogonal to the longitudinal direction of the cleaning part 21 circular as illustrated in FIG. 7A, the cross-sectional shape in the direction orthogonal to the longitudinal direction of the cleaning part 21 is made non-circular as illustrated in FIGS. 7B to 7G, the ability to remove foreign material improves as the efficacy of scraping off the foreign material improves. In addition, as in FIGS. 7B to 7G, when the cross-sectional shape of the cleaning part 21 is non-circular, the diameter of a circle circumscribed thereabout corresponds to the maximum outer diameter D.

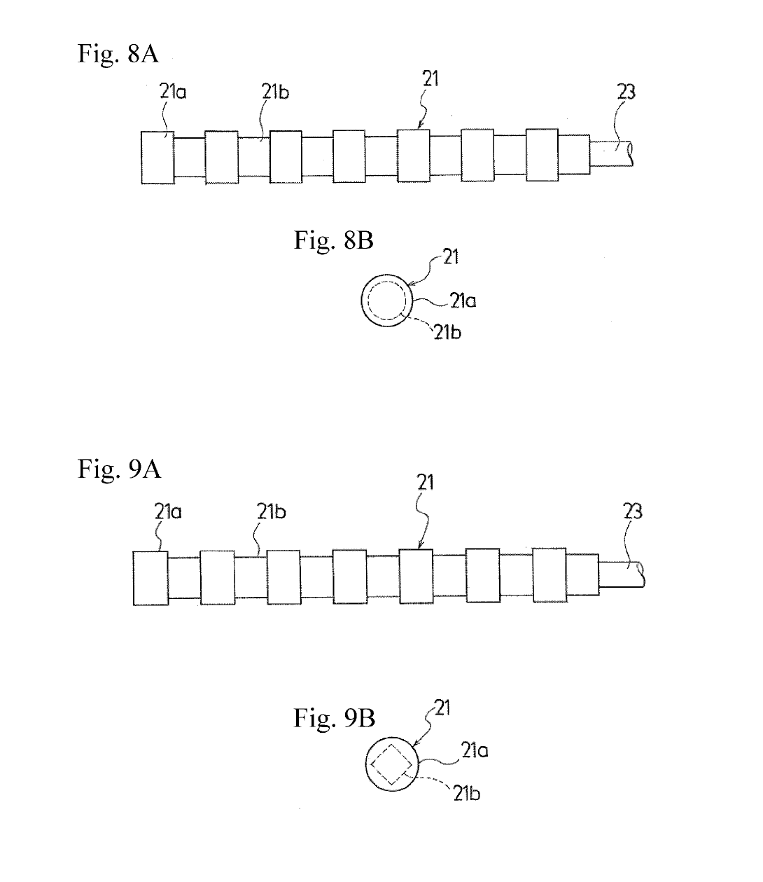

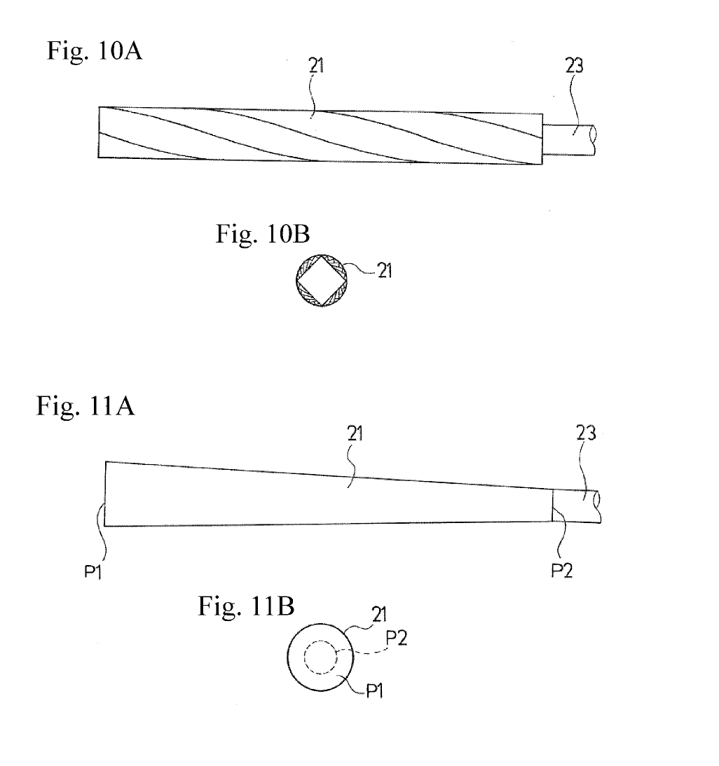

FIGS. 8A and 8B to FIGS. 12A and 12B respectively illustrate various cleaning parts of the tire valve cleaning tool used in the present technology. In FIGS. 8A and 8B, the outer diameter of the cleaning part 21 varies along the longitudinal direction with a plurality of thick sections 21a and a plurality of thin sections 21b alternately disposed along the longitudinal direction. In FIGS. 9A and 9B, the outer diameter of the cleaning part 21 varies along the longitudinal direction with a plurality of thick sections 21a and a plurality of thin sections 21b alternately disposed along the longitudinal direction. The cross-sectional shape of a thick section 21a is circular, while the cross-sectional shape of the thin section 21b is square. In the examples in FIGS. 8A and 8B, and FIGS. 9A and 9B, the foreign material is easily trapped in the thin section 21b when the cleaning part 21 moves in the tire valve 10 along the longitudinal direction, and thus the ability to remove the foreign material improves. In this manner, when the outer diameter of the cleaning part 21 varies along the longitudinal direction, it is possible to mix together two or more types of sections where the outer diameters mutually differ along the longitudinal direction.

In FIGS. 10A and 10B, the cross-sectional shape of the cleaning part 21 is non-circular (square); the shape is varied along the longitudinal direction with a twist given along the longitudinal direction. In the example of FIGS. 10A and 10B, the edge of the cleaning part 21 will scrape off the foreign material when the cleaning part 21 moves in the tire valve along the longitudinal direction; and thus the ability to remove foreign material improves.

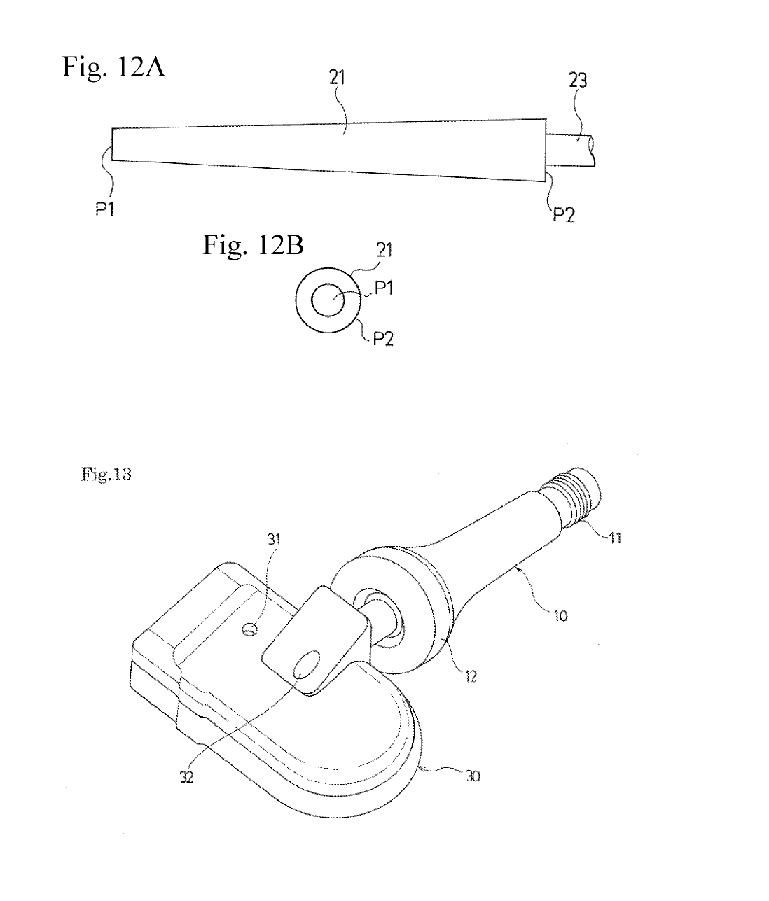

In FIGS. 11A and 11B, the cleaning part 21 gradually becomes thinner from a tip end position P1 to a base end position P2. In FIGS. 12A and 12B, the cleaning part 21 gradually becomes thicker from the tip end position P1 to the base end position P2. In the examples in FIGS. 11A and 11B, and 12A and 12B, the outer diameter of the cleaning part 21 varies gradually in the longitudinal direction, therefore, the contact pressure with respect to the inner face of the tire valve 10 changes when the cleaning part 21 moves inside the tire valve 10 in the longitudinal direction to effectively scrape off the foreign material.

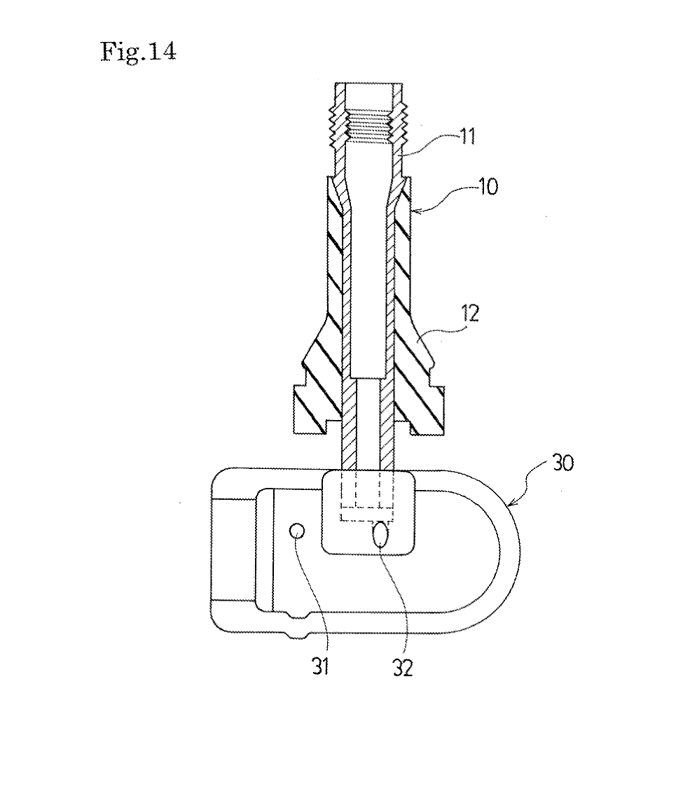

FIGS. 13 and 14 illustrate a tire valve provided with a sensor unit. A sensor unit 30 has a built-in detecting device which detects tire internal information such as air pressure and temperature, and is installed integrally into the tire valve 10. The sensor unit 30 is provided with a vent 31, and a communication hole 32. The detecting device inside the sensor unit 30 senses the state of the air filling the tire by way of the vent 31. Additionally, the tire valve 10 is such that it communicates with the inside of the tire by way of the communication hole 32.

In this case, appropriately cleaning the tire valve 10 provided with the sensor unit 30 after the puncture repair fluid has been injected thereby allows continued use without having to replace the tire valve 10 provided with the expensive sensor unit 30.

The above was a detailed description of a preferred embodiment of the present technology, but it should be understood that various changes, substitutions, and replacements can be made to this embodiment, provided that they do not deviate from the spirit and scope of the present technology as specified in the attached scope of claims.

### EXAMPLES

Tire valve cleaning tools of Working Examples 1 to 8 and Comparative Examples 1 to 4 were manufactured, provided with a cleaning part made from a flexible member, and a holder part that communicates with the cleaning part. A ratio of the maximum outer diameter of the cleaning part to the minimum inner diameter of the tire valve; a length of the cleaning part; and a cross-sectional shape in the direction orthogonal to the longitudinal direction of the cleaning part were set as shown in Table 1.

Then, the valve core was removed from a tire valve installed on a wheel, puncture repair fluid was injected via the tire valve, and thereafter, the tire valve cleaning tool of Working Examples 1 to 8 and Comparative Examples 1 to 4 were used to remove the foreign material adhered to the inner face of the tire valve with the cleaning part.

During the above-mentioned foreign material removal process, the insertability, operability, and efficacy of removing foreign material for the tire valve cleaning tool was evaluated on the basis of the following criteria. The results are shown collectively in Table 1.

### Insertability

The ease of insertion when inserting the tire valve cleaning tool into the tire valve was evaluated. The evaluation results are indicated by ‘A’ if the insertion operation was extremely smooth; indicated by ‘B’ if the insertion operation was performed without problems; indicated by ‘C’ if the insertion operation tended to be somewhat difficult but was sufficiently possible; and indicated by ‘D’ if the insertion operation tended to be extremely difficult.

### Operability

The operability when inserting the tire valve cleaning tool inside to clean the tire valve was evaluated. The evaluation results are indicated by ‘A’ if the cleaning operation was smooth; indicated by ‘B’ if the cleaning operation was performed without problems; indicated by ‘C’ if the cleaning operation tended to be somewhat difficult but was sufficiently possible; and indicated by ‘D’ if the cleaning operation tended to be extremely difficult. Efficacy in Removing Foreign Material

The efficacy of removing foreign material with the tire valve cleaning tool was evaluated. The evaluation results are indicated by ‘A’ if the foreign material was substantially completely removed; indicated by ‘B’ if the foreign material was mostly removed; indicated by ‘C’ if most of the foreign material remained but it did not affect the functioning of the tire valve; and indicated by ‘D’ if remaining foreign material caused loss of function of the tire valve.

TABLE 1

| | | Comparative | Comparative | Working | Working | Working | Working | Working |
|---|---|---|---|---|---|---|---|---|
| | | Example 1 | Example 2 | Example 1 | Example 2 | Example 3 | Example 4 | Example 5 |
| Cleaning | Maximum | 40 | 40 | 50 | 50 | 100 | 100 | 100 |
| Part | Outer | | | | | | | |
| | Diameter | | | | | | | |
| | Ratio (%) | | | | | | | |
| | Length | 20 | 20 | 20 | 20 | 5 | 20 | 50 |
| | (mm) | | | | | | | |
| | Cross- | Circular | Non-circular | Circular | Non- | Circular | Circular | Circular |
| | sectional | | | | circular | | | |
| | shape | | | | | | | |

| | | | | | | | |
|---|---|---|---|---|---|---|---|
| Insertability | A | A | A | A | A | A | B |
| Operability | A | A | A | A | B | A | A |
| Efficacy in | D | D | C | B | B | B | B |
| Removing Foreign | | | | | | | |
| Material | | | | | | | |

| | | Working | Working | Working | Comparative | Comparative |
|---|---|---|---|---|---|---|
| | | Example 6 | Example 7 | Example 8 | Example 3 | Example 4 |
| Cleaning | Maximum | 100 | 150 | 150 | 210 | 210 |
| Part | Outer | | | | | |
| | Diameter | | | | | |
| | Ratio (%) | | | | | |
| | Length | 20 | 20 | 20 | 20 | 20 |
| | (mm) | | | | | |
| | Cross- | Non- | Circular | Non- | Circular | Non-circular |
| | sectional | circular | | circular | | |
| | shape | | | | | |

| | | | | | |
|---|---|---|---|---|---|
| Insertability | A | C | B | D | D |
| Operability | A | C | B | D | D |
| Efficacy in Removing | A | B | A | D | D |
| Foreign Material | | | | | |

As can be understood from Table 1, the evaluation results for insertability, operability, and efficacy of removing foreign material were favorable when using a tire valve cleaning tool of Working Examples 1 to 8 to remove the foreign material adhered to the inner face of a tire valve. Concerning this, while the insertability and operability were satisfactory in the case of Comparative Examples 1 and 2, the efficacy of removing foreign material was unsatisfactory. Additionally, in the case of Comparative Examples 3 and 4, given that the insertability and operability were bad, the efficacy of removing foreign material was also unsatisfactory.

1. A method of cleaning a tire valve, comprising: using a tire valve cleaning tool including a cleaning part made from a flexible member, and a holder part that communicates with the cleaning part, a maximum outer diameter of the cleaning part being from 50% to 200% of a minimum inner diameter of the tire valve; removing a valve core from the tire valve installed on a wheel; and removing a foreign material adhered to an inner face of the tire valve with the cleaning part.

2. The method of cleaning a tire valve according to claim 1, wherein a length of the cleaning part is from 5 mm to 100 mm.

3. The method of cleaning a tire valve according to claim 1, wherein the cleaning part has a core running along a longitudinal direction of the cleaning part.

4. The method of cleaning a tire valve according to claim 1, wherein a cross-sectional shape of the cleaning part in a direction orthogonal to a longitudinal direction of the cleaning part is non-circular.

5. The method of cleaning a tire valve according to claim 1, wherein the outer diameter or a shape of the cleaning part is varied along a longitudinal direction of the cleaning part.

6. The method of cleaning a tire valve according to claim 1, wherein the tire valve cleaning tool includes a pair of cleaning parts that function as the cleaning part; a first cleaning part being made from an absorber that functions to absorb a liquid-state foreign material, and a second cleaning part being made from a scraper that functions to scrape off a solid-state foreign material.

7. A tire valve cleaning tool comprising: a cleaning part made from a flexible member; and a holder part that communicates with the cleaning part; a maximum outer diameter of the cleaning part being from 50% to 200% of a minimum inner diameter of a tire valve.

8. The tire valve cleaning tool according to claim 7, wherein a length of the cleaning part is from 5 mm to 100 mm.

9. The tire valve cleaning tool according to claim 7, wherein the cleaning part has a core running along a longitudinal direction of the cleaning part.

10. The tire valve cleaning tool according to claim 7, wherein a cross-sectional shape of the cleaning part in a direction orthogonal to a longitudinal direction of the cleaning part is non-circular.

11. The tire valve cleaning tool according to claim 7 wherein the outer diameter or a shape of the cleaning part is varied along a longitudinal direction of the cleaning part.

12. The tire valve cleaning tool according to claim 7, comprising a pair of cleaning parts that function as a cleaning part; a first cleaning part being made from an absorber that functions to absorb a liquid-state foreign material, and a second cleaning part being made from a scraper that functions to scrape off a solid-state foreign material.

13. The method of cleaning a tire valve according to claim 2, wherein the cleaning part has a core running along a longitudinal direction of the cleaning part.

14. The method of cleaning a tire valve according to claim 13, wherein a cross-sectional shape of the cleaning part in a direction orthogonal to the longitudinal direction of the cleaning part is non-circular.

15. The method of cleaning a tire valve according to claim 14, wherein the outer diameter or a shape of the cleaning part is varied along the longitudinal direction of the cleaning part.

16. The method of cleaning a tire valve according to claim 15, wherein the tire valve cleaning tool includes a pair of cleaning parts that function as the cleaning part; a first cleaning part being made from an absorber that functions to absorb a liquid-state foreign material, and a second cleaning part being made from a scraper that functions to scrape off a solid-state foreign material.

17. The tire valve cleaning tool according to claim 8, wherein the cleaning part has a core running along a longitudinal direction of the cleaning part.

18. The tire valve cleaning tool according to claim 17, wherein a cross-sectional shape of the cleaning part in a direction orthogonal to the longitudinal direction of the cleaning part is non-circular.

19. The tire valve cleaning tool according to claim 18, wherein the outer diameter or a shape of the cleaning part is varied along the longitudinal direction of the cleaning part.

20. The tire valve cleaning tool according to claim 19, comprising a pair of cleaning parts that function as a cleaning part; a first cleaning part being made from an absorber that functions to absorb a liquid-state foreign material, and a second cleaning part being made from a scraper that functions to scrape off a solid-state foreign material.
